(19) United States
(12) Patent Application Publication
(10) Pub. No.: US 2018/0066610 A1
(43) Pub. Date: Mar. 8, 2018

(54) DEDICATED EGR ENGINE WITH DEDICATED LOOP TURBOCHARGER

(71) Applicant: BorgWarner Inc., Auburn Hills, MI (US)

(72) Inventor: DAVID B. ROTH, Groton, NY (US)

(21) Appl. No.: 15/257,414

(22) Filed: Sep. 6, 2016

(51) Int. Cl. F02M 26/08; F02B 37/00; F02B 37/013; F02M 26/34; F02M 26/43

(52) U.S. Cl. CPC F02M 26/08; F02B 37/001; F02M 26/43; F02M 26/34; F02B 37/013

(57) ABSTRACT

A product may include an engine that may have a set of cylinders with one cylinder that may deliver a first stream of exhaust gases to a first conduit and other cylinders that may deliver a second stream of exhaust gases to a second conduit. An intake system may supply the set of cylinders with a combustion air. First and second turbochargers may be provided wherein the combustion air may be charged in the intake system through first and second compressors. The first stream of exhaust gases from the one cylinder may be routed through the first turbine.

### TECHNICAL FIELD

The field to which the disclosure generally relates includes the use of the flow of exhaust gases from an internal combustion engine, and in particular, includes the use of exhaust gases for turbocharging.

### BACKGROUND

Internal combustion engine systems include engines having combustion chambers in which air and fuel may be combusted for conversion into mechanical power. Combustion engine systems may also include breathing systems including intake systems upstream of the engine for conveying intake gases to the combustion chambers, and exhaust systems downstream of the engine for carrying exhaust gases away from the combustion chambers.

Combustion engine systems may also be equipped with turbochargers to pressurize the intake air before entry into the combustion chambers to efficiently increase engine power.

### SUMMARY OF ILLUSTRATIVE VARIATIONS

A number of variations may include a product with an engine that may have a set of cylinders with one cylinder that may deliver a first stream of exhaust gases to a first conduit and other cylinders that may deliver a second stream of exhaust gases to a second conduit. An intake system may supply the set of cylinders with a combustion air. First and second turbochargers may be provided wherein the combustion air may be charged in the intake system through first and second compressors. The first stream of exhaust gases from the one cylinder may be routed through the first turbine.

Additional variations may involve a product that may include an engine that may have a first cylinder and a number of additional cylinders. A first turbocharger may include a first turbine and a first compressor. A first stream of exhaust gases from the first cylinder may be channeled through the first turbine. A second turbocharger may include a second turbine and a second compressor. A second stream of exhaust gases from the number of additional cylinders may be channeled through the second turbine. An air inlet may provide a combustion air to the engine that may be channeled first through the first compressor and second through the second compressor and then into the engine.

Other illustrative variations within the scope of the invention will be apparent from the detailed description provided herein. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a schematic view of a number of variations of a product with an internal combustion engine system;

FIG. 2 is a schematic view of a number of variations of a product with an internal combustion engine system;

FIG. 3 is a schematic view of a number of variations of a product with an internal combustion engine system;

FIG. 4 is a schematic view of a number of variations of a product with an internal combustion engine system;

FIG. 5 is a schematic view of a number of variations of a product with an internal combustion engine system; and

FIG. 6 is a diagrammatic illustration of a number of variations of methods for an internal combustion engine system.

### DETAILED DESCRIPTION OF ILLUSTRATIVE VARIATIONS

The following description of the variations is merely illustrative in nature and is in no way intended to limit the scope of the invention, its application, or uses.

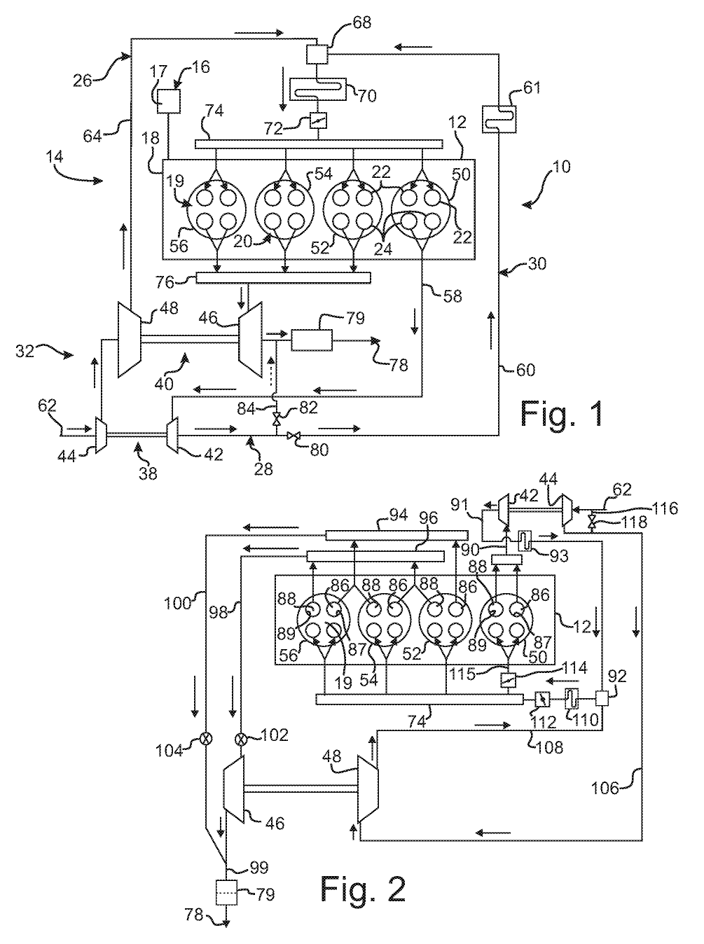

In a number of variations as illustrated in FIG. 1, a system of utilizing exhaust gas flow to increase performance may involve dividing flow between multiple circuits. In a number of variations the divided flow may be used to provide multiple boost stages. The system may be carried out using a suitable breathing circuit and, more specifically, may be carried out in conjunction with an engine system such as product 10. In a number of variations a dedicated EGR system may be used. A dedicated EGR system may involve recirculating exhaust gas from a dedicated cylinder, or cylinders, to the intake system of the engine. It has been found that such a system may increase performance. For example, fuel efficiency may be improved. The dedicated cylinder(s) may be operated to optimize the performance improvement in a number of ways. For example, in a number of variations the dedicated cylinder(s) may be run with a richer fuel/air mixture than the other cylinders. The intake mixture may be tailored to generate an exhaust gas stream from the dedicated cylinder(s) with constituents that support a performance increase, such as those that are high in octane. Recirculating the tailored exhaust gas stream through the intake system and into the engine where combustion results, can achieve the desired effects. The variations described herein advantageously improve the low-speed boost of such an engine, and also reduce the pressure and flow fluctuations in the dedicated EGR line. These advantages may be accomplished through the approaches to dedicated EGR described herein, and the variations of structuring a boosted engine breathing system. The following system descriptions provide an overview of desired engine system variants, but other systems and components not shown here could also be included in the covered variations.

In general, the product 10 may include an internal combustion engine 12 that may combust a mixture of fuel and intake gases for conversion into mechanical rotational energy. An engine breathing system 14 may deliver intake gases to the engine 12 and may carry exhaust gases away from the engine 12. The product 10 may also include a fuel subsystem (not shown) to provide any suitable liquid and/or gaseous fuel to the engine 12 for combustion therein with the intake gases, and may include a control subsystem 16 to control operation of the product 10.

The internal combustion engine 12 may be any suitable type of engine such as, a spark-ignition engine such as a gasoline engine, an autoignition or compression-ignition engine such as a diesel engine, or another type that uses a breathing system. The engine 12 may include a block 18 with cylinders containing pistons 19, which, along with a cylinder head, may define combustion chambers 20 for internal combustion of a mixture of fuel and intake gases. The engine 12 may also include any suitable quantities of intake valves 22 controlling intake ports and exhaust valves 24 controlling exhaust ports. The engine 12 may include any quantity of cylinders, and may be of any size and may operate according to any suitable speeds and loads. Valve timing may be regulated by camshafts or valve solenoids or another known method to open/close the ports by moving the valves.

In a number of variations, the engine breathing system 14 may include an intake subsystem 26 that may compress and cool intake air/gases and convey them to the engine 12, and an exhaust subsystem 28 that may extract energy from exhaust gases and that may recirculate, and/or carry them away from, the engine 12. The engine breathing system 14 may include an exhaust gas recirculation (EGR) subsystem 30 that may be in communication across the exhaust and intake subsystems 26, 28 to recirculate exhaust gases that may be mixed with air for supply to the combustion process of the engine system 10. The engine breathing system 14 may include a turbocharging system 32 for the intake and exhaust subsystems 26, 28 to compress inlet air and improve combustion to increase engine power output and/or performance. As used herein, the phrase intake gases may include fresh air, compressed air, vapor, other gases, and/or recirculated exhaust gases.

The turbocharging subsystem 32 may be a single stage system or, as shown, may be a multi-stage turbocharging subsystem. In a number of variations, the turbocharging subsystem 32 may include a first turbocharger 38 and may also include a second turbocharger 40, which may be arranged as first and second stages. For example, the first turbocharger 38 may be a relatively small turbocharger that may be optimized for high impulse turbine flow. The second turbocharger 40 may be a relatively large turbocharger compared to the first turbocharger 38. One or both of the turbochargers 38, 40 may be variable turbine geometry (VTG) types of turbochargers, dual-stage turbochargers, or turbochargers with waste gate or bypass devices, or may include other known capabilities. The turbochargers 38, 40 and/or any turbocharger accessory device(s) may be adjusted to affect any one or more of the following exemplary parameters: turbocharger boost pressure, air mass flow, and/or EGR flow.

The first turbocharger 38 may include a first turbine 42 and a first compressor 44 that may be mechanically coupled to the first turbine 42, such as by a shaft. The second turbocharger 40 may include a second turbine 46 and a second compressor 48 that may be mechanically coupled to the first turbine 46, such as by a shaft. The EGR subsystem 30 may be a dedicated EGR system, meaning that one cylinder 50 of the engine 12 may be dedicated to supplying EGR flow. The other cylinders 52, 54, 56 may not supply EGR flow, or may selectively supply flow. An exhaust conduit 58 may lead from the cylinder 50 to the first turbine 42. An exhaust conduit 60 may channel outflow from the first turbine 42 and may be routed to the intake subsystem 26. The outflow may be routed through an EGR cooler 61, which may be a heat exchanger provided in the conduit 60 to cool the flow there-through.

The intake subsystem 26 may include, in addition to suitable conduits and connectors, an inlet end 62 which may have an air filter (not shown), to filter incoming air. The intake subsystem 26 may include the turbocharger compressors 44, 48 that may be staged and may be located downstream of the inlet end 62 to compress the inlet air. From the second compressor 48, a conduit 64 may lead to a mixer 68, where charged intake air from the compressors 44, 48 may be mixed with EGR flow from the conduit 60. The intake subsystem 26 may also include an intercooler 70, which may be a heat exchanger located downstream of the turbocharger compressors 44, 48 to cool the compressed air. An intake throttle valve 72 may be located downstream of the intercooler 70 to throttle the flow of the cooled air/gases to the engine 12. The intake subsystem 26 also may include an intake manifold 74 downstream of the throttle valve 72 and upstream of the engine 12, to receive the throttled air and distribute it to the engine combustion cylinders 50, 52, 54, 56. The intake subsystem 26 may also include any other suitable devices. Accordingly, intake air may be compressed by the first compressor 44 as a first stage compression, and by the second compressor 48 as a second stage compression, and may then be mixed with EGR flow from conduit 60 for supply to the engine 12. The EGR flow may be supplied from the cylinder 50 as a dedicated source.

In a number of variations, the exhaust subsystem 28 may include, in addition to suitable conduit and connectors, an exhaust manifold 76 to collect exhaust gases from the combustion chambers of cylinders 52, 54 and 56. In a number of variations the exhaust manifold 76 may not collect exhaust gases from the cylinder 50, which may be separately routed. The exhaust manifold 76 may channel the exhaust gases from the cylinders 52, 54 and 56 to the second turbine 46, and downstream therefrom to the rest of the exhaust subsystem 28 for discharge to the atmosphere at discharge end 78. The exhaust subsystem 28 may include a treatment device 79 downstream from the second turbine 46, which may be a catalytic converter, absorber, filter, or other exhaust treatment device. While the cylinder 50 may supply all of the EGR flow for the engine 12 through conduit 60, it may also selectively deliver exhaust gases through the first turbine 42 to the treatment device 79, when desirable, such as during a cold startup of the engine 12 to shorter light-off time. A pair of valves 80, 82 may be controlled to divert flow leaving the first turbine 42 from flowing through the conduit 60 to flowing through the conduit 84 for supply to the treatment device 79. Instead of the two valves 80, 82, one three-way valve may be used to provide outflow to the conduit 60 and/or to the conduit 84. Routing the EGR flow through the first stage turbocharger 38 may increase performance of the engine 12 by extracting energy from the EGR gas flow to charge the intake air as an addition to the second stage turbocharger 40. The first turbine 42 may also provide a benefit by cooling the dedicated EGR feed gases to the cylinders 50, 52, 54 and 56, and may reduce pressure fluctuations in the exhaust flow leaving the cylinder 50.

In a number of variations, the control subsystem 16 may include any suitable hardware, software, and/or firmware to carry out at least some portions of the operations, steps and methods disclosed herein. For example, the control subsystem 16 may include various engine system actuators and sensors. The engine system sensors are not individually shown in the drawings but may include any suitable devices to monitor engine system parameters. For example, an engine speed sensor may measure the rotational speed of an engine crankshaft, pressure sensors in communication with the engine combustion chambers 20 may measure engine cylinder pressure, intake and exhaust manifold pressure sensors may measure pressure of gases flowing into and away from the combustion chambers, an inlet air mass flow sensor may measure incoming airflow in the induction subsystem 26, and/or an intake manifold mass flow sensor may measure flow of induction gases to the engine 12. In other variations, temperature sensors may measure the temperature of intake gases flowing to the engine 12. In additional variations, the engine system 10 may include a speed sensor suitably coupled to one or both of the turbochargers 38, 40 to measure the rotational speed thereof. A throttle position sensor, such as an integrated angular position sensor, may measure the position of the throttle valve 72. A position sensor may be disposed in proximity to the turbochargers 38, 40 to measure the position of VTG blades, if provided. A tailpipe temperature sensor may be placed upstream of a tailpipe outlet to measure the temperature of the exhaust gases exiting the exhaust subsystem. Also, temperature sensors may be placed upstream and downstream of the emissions device(s) to measure the temperature of exhaust gases at the inlet(s) and outlet(s) thereof. Similarly, one or more pressure sensors may be placed across the emissions device(s) to measure the pressure drop thereacross. An oxygen (O₂) sensor may be placed in the exhaust and/or induction subsystems to measure oxygen in the exhaust gases and/or induction gases. Position sensors may measure the positions of the included valves.

In addition to the sensors discussed herein, any other suitable sensors and their associated parameters may be encompassed by the presently disclosed system and methods. For example, the sensors may also include accelerator sensors, vehicle speed sensors, powertrain speed sensors, filter sensors, other flow sensors, vibration sensors, knock sensors, intake and exhaust pressure sensors, and/or the like. Sensors may be used to sense any suitable physical parameters including electrical, mechanical, and chemical parameters. As used herein, the term sensor may include any suitable hardware and/or software used to sense any engine system parameter and/or various combinations of such parameters.

The control subsystem 16 may further include one or more controllers 17, in communication with the actuators and sensors for receiving and processing sensor input and transmitting actuator or other output signals. The controller(s) may include one or more suitable processors and memory devices. The memory may be configured to provide storage of data and instructions that provide at least some of the functionality of the engine system 10 and that may be executed by the processor(s). At least portions of methods disclosed herein may be enabled by one or more computer programs and various engine system data or instructions stored in memory as look-up tables, formulas, algorithms, maps, models, or the like. In a number of variations, the control subsystem 16 may control engine system parameters by receiving input signals from the sensors, executing instructions or algorithms in light of sensor input signals, and transmitting suitable output signals to the various actuators. As used herein, the term “model” may include any construct that represents something using variables, such as a look up table, map, formula, algorithm and/or the like. Models may be application specific and particular to the exact design and performance specifications of any given engine system.

In a number of variations as illustrated in FIG. 2, the engine 12 may also have the cylinder 50 that may be dedicated to supplying the EGR flow to the intake manifold 74. Each of the cylinders 50, 52, 54 and 56 may have a pair of exhaust valves 86, 88 controlling exhaust ports 87, 89. The exhaust valves 86 and 88 of the cylinder 50 may be connected to a common conduit 90 to feed all exhaust outflow from cylinder 50 to the first turbine 42. Outflow from the first turbine 42 may be delivered as EGR flow through conduit 91 toward the intake manifold 74 to a mixer 92. An EGR cooler 93 may be provided in the conduit 91 as a heat exchanger to remove heat from the EGR gases to be recirculated to the intake manifold 74. The cylinders 52, 52 and 56 may have their ports 87, as controlled by exhaust valves 86, connected to a scavenge exhaust manifold 94, and may have their ports 89, as controlled by exhaust valves 88, connected to a blowdown exhaust manifold 96. In a cycle of the engine 12, the exhaust valves 88 of the cylinders 52, 54 and 56, may open such as immediately before their corresponding piston 19 reaches a bottom dead center (BDC) position and soon thereafter about half of all combusted induction gases may exit the combustion chambers under relatively high pressure. This may commonly be referred to as a blowdown phase of the exhaust portion of the engine cycle. As the piston may then further sweep upward toward a top dead center position (TDC), the valves 88 may be closed and the valves 86 may be opened, and the pistons 19 may then displace most/all of the remaining combusted intake gases out of the combustion chambers of cylinders 52, 54 and 56, as exhaust gases under relatively lower pressure. This may commonly be referred to as a scavenging phase of the exhaust portion of the engine cycle. The lift curves for the exhaust valves 86, 88 of the cylinder 50 may be separately optimized from the exhaust valves of the cylinders 52, 54 and 56. The blowdown exhaust manifold 96 may be connected to supply gases downstream through a conduit 98 to the second turbine 48. Outflow from the second turbine 48 may be routed through a conduit 99 to the treatment device 79, and there-through to the discharge end 78 for discharge. The scavenge exhaust manifold 94 may be connected to supply gases downstream through a conduit 100 to the conduit 99 bypassing the second turbine 48. One more variable restriction valves 102, 104, such as backpressure valve(s), may be located in the conduits 100, 98 respectively, to enable variations in exhaust energy delivered to the second turbine 48, such as to increase delivery at low engine speed.

In a number of variations, air drawn into the first compressor 44 from the inlet end 62, may be supplied through a conduit 106 to the second compressor 48. Air may be supplied downstream from the second compressor 48 through a conduit 108 to the mixer 92 for mixing with the EGR flow from conduit 91. The mixed gases may be supplied to the intake manifold 74 through a charge air cooler 110 and a throttle valve 112. A second throttle valve 114 may be disposed in the flow path 115 from the intake manifold 74 to the cylinder 50 so that the flow of combustion gases to the cylinder 50 may be individually controlled separate from flow to the cylinders 52, 54 and 56. In a number of variations, a bypass conduit 116 may connect the inlet end 62 with the conduit 106. A valve 118 may be provided in the bypass conduit 116, which may be opened so that intake air may bypass the relatively small compressor 44, such as during high power requirements, freeing flow to the relatively larger second compressor 48 from the restriction of the first compressor 44.

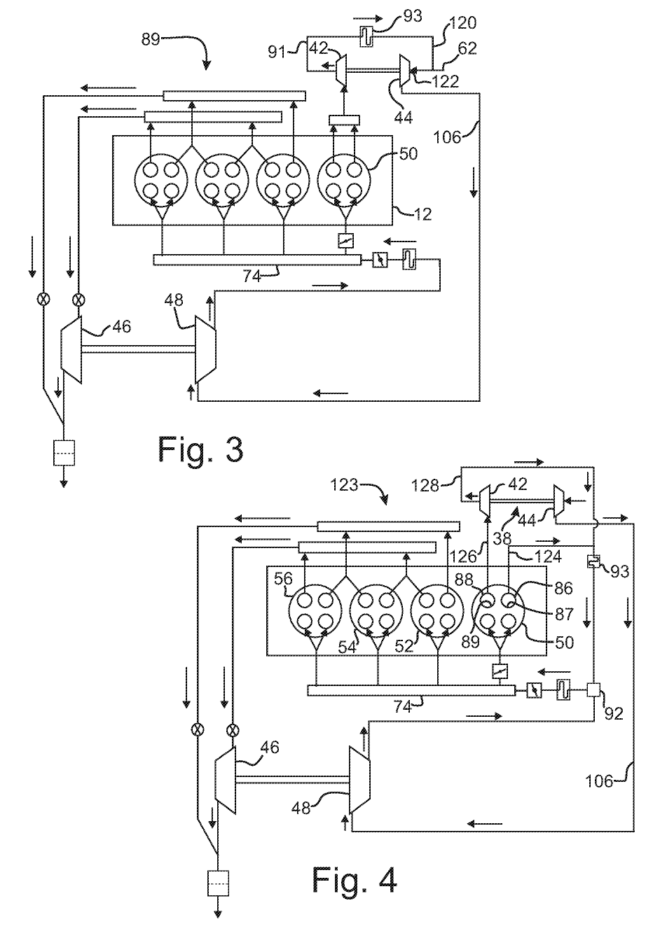

In a number of variations as illustrated in FIG. 3, a product 89 may omit the mixer 92 of the variations of FIG. 2. EGR flow leaving the EGR cooler 93 may be routed through a conduit 120 to the intake 122 of the first compressor 44. The EGR flow from cylinder 50 may be mixed in the first compressor 44 with air drawn in through the inlet end 62. In a number of variations, all of the output from cylinder 50 may be routed through the first turbine 42 and then through the first compressor 44 before delivery through the second compressor 48 to the intake manifold 74. This may provide an improved pressure change across the first turbine and may deliver 25 percent dedicated EGR to the engine 12. Other aspects of the variations of FIG. 3 may be the same or similar to the aspects of the variations of FIG. 2. For example, similar to the variations illustrated in FIG. 2, a bypass may be included around the first compressor 44, such as for high power requirements of the engine 12.

In a number of variations as illustrated in FIG. 4, a product 123 may include a divided exhaust period head for the cylinder 50 in addition to those of the cylinders 52, 54 and 56. The port 87, as controlled by the exhaust valve 86 may provide a flow path leading to a scavenge exhaust passage 124. The port 89, as controlled by the exhaust valve 88, may provide a flow path leading to a blowdown exhaust passage 126. The blowdown exhaust passage 126 may lead to the first turbine 42 to provide power to drive the first compressor 44. Blowdown exhaust gas leaving the first turbine 42 may move downstream through a conduit 128 to the EGR cooler 93, and there-through to the mixer 92 where it may be mixed with intake air for supply to the intake manifold 74. Scavenge exhaust gas routed through the scavenge exhaust passage 124 may flow directly to the conduit 128 where it may join with the blowdown exhaust gas leaving the first turbine 42. Accordingly, the exhaust gas leaving the cylinder 50 may be split into blowdown exhaust gas that may be routed through the first turbine 42, and scavenge exhaust gas that may bypass the first turbine 42, but which may then join the blowdown exhaust gas for supply to the intake manifold 74 as EGR gas flow. As a result, pumping mean effective pressure and residual gas fraction of the first turbocharger 38 may be advantageously lower than a non-divided exhaust period for the cylinder 50, by isolating the piston and high pressure from the scavenging exhaust passage 124 during much of the exhaust stroke. Pumping mean effective pressure penalties due to pumping parasitic losses at small nozzle openings may be reduced when turbine energy is delivered by the blowdown exhaust valve path of blowdown exhaust passage 126 because exhaust backpressure acting on the piston during exhaust may be minimally affected by high backpressure at the inlet to the first turbine 42.

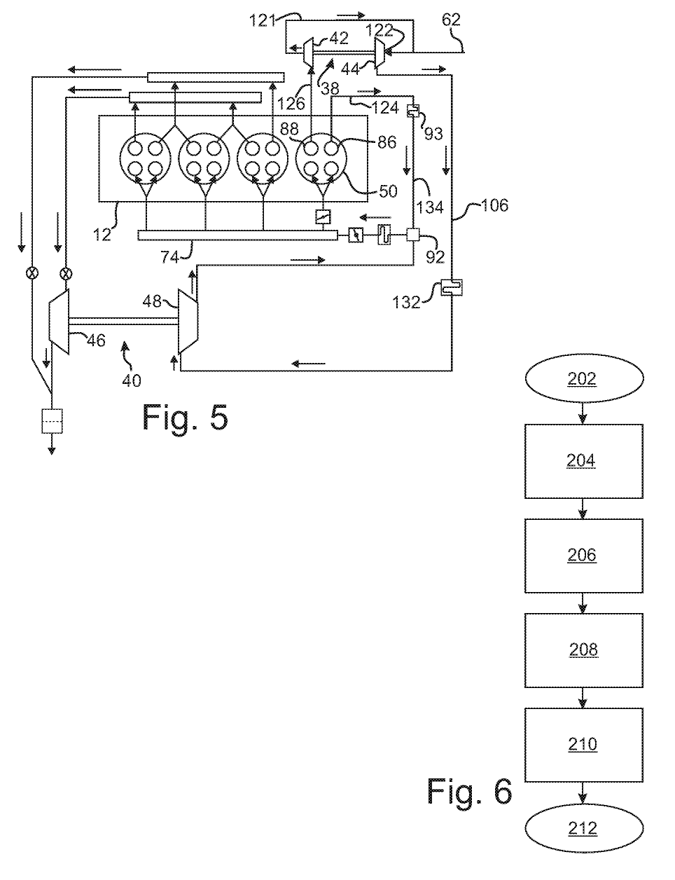

In a number of variations as illustrated in FIG. 5, the engine 12 may include any suitable valve timing devices to actuate the exhaust valves 86, 88. In a number of variations the product may use a divided exhaust period head with valve event modulated boost. In a number of variations, individual actuators such as solenoids (not shown) may be used to actuate the exhaust valves 86, 88. In other variations, a cam device may be used to actuate each of the exhaust valves 86, 88. In a number of variations the timing and/or lift of the exhaust valves 86, 88 may be controlled by adjusting their phase or angle. In general, optimal valve timing of blowdown valves 88 and scavenging valves 86 will be application specific and, thus, will vary from engine to engine. In a number of variations, the blowdown valves 88 may have relatively advanced timing, may have longer valve opening duration, and/or may have higher lift than the scavenging valves 86. In one variation, the lift of the blowdown valves 88 may be the maximum lift attainable in approximately 180 degrees of crank angle, and the lift of the scavenging valves 86 may be the maximum lift attainable in approximately 160 degrees of crank angle.

In a number of variations the cylinder 50 may be provided with the exhaust valve 86 providing a flow path leading to a scavenge exhaust passage 124, and with the exhaust valve 88 providing a flow path leading to a blowdown exhaust passage 126. The blowdown exhaust passage 124 may lead to the first turbine 42 to provide power to drive the first compressor 44. Blowdown exhaust gas leaving the first turbine 42 may move downstream through a conduit 121 to the intake 122 of the first compressor 44. The first compressor 44 may charge and mix the blowdown exhaust gas from cylinder 50 and intake air drawn in through the inlet end 62. The mixed gas streams may be supplied to the second compressor 48 through the conduit 106, which may include a cooler 132. Scavenge exhaust gas may be delivered through the scavenge exhaust passage 124 and may flow directly to the EGR cooler 93 and the conduit 134 to the mixer 92 for supply to the intake manifold 74. Accordingly, the exhaust gas leaving the cylinder 50 may be split into blowdown exhaust gas that may be routed through the first turbine 42, and then through the first compressor 44, and then through the second compressor 48 before being delivered to the intake manifold 74. Scavenge exhaust gas may be routed to the intake manifold 74 without passing through any turbine or any compressor. This may provide an advantageous power level to the first and second stage turbochargers 38, 40.

In a number of variations methods of providing turbocharging and EGR may be carried out through the variations of FIGS. 1-5 with one or more computer programs within the operating environment of the engine system 10 described above. Those skilled in the art will also recognize that the methods may be carried out using other engine systems within other operating environments. Referring to FIG. 6, a method 200 according to a number of variations is illustrated in flow chart form. As shown at step 202, the method 200 may be initiated in any suitable manner. For example, the method 200 may be initiated at startup of the engine 12 of any of the engine systems of FIGS. 1-5.

At step 204, fresh air may be drawn into an intake subsystem of an engine system through which intake gases may be inducted into an engine. For example, fresh air may be drawn into the inlet end 62 and intake gases may be inducted into the engine 12 through the intake manifold 74. At step 206, exhaust gases may be exhausted from an engine through an exhaust subsystem of an engine system. For example, exhaust gases may be exhausted from the engine 12 through the exhaust manifold 76, 94, 96. At step 208, EGR exhaust gases may be provided from one dedicated cylinder to a first stage turbine of a first stage turbocharger. In a number of variations, all exhaust gases may be provided from the cylinder 50 to the first turbine 42 for extracting energy and driving a first compressor 44, and for providing EGR requirements of the engine 12. In a number of variations, EGR exhaust gases may be provided entirely by blowdown exhaust gases from the cylinder 50. In such a case, the scavenging gases from the cylinder 50 may also be provided for EGR but may bypass the first turbine 42. At step 210, energy from exhaust gases may be extracted and converted to energy to compress intake gases, such as into the intake manifold 74. One or both of the first turbocharger 38 and the second turbocharger 40 may be used to charge the intake gases. At step 212 the method 200 may be suspended in any suitable manner. For example, the method 200 may be suspended at shutdown of the engine 12.

The method 200 or any portion thereof may be performed as part of a product such as the system 10, and/or as part of a computer program that may be stored and/or executed by the control subsystem 16. The computer program may exist in a variety of forms both active and inactive. For example, the computer program can exist as software program(s) comprised of program instructions in source code, object code, executable code or other formats; firmware program(s); or hardware description language (HDL) files. Any of the above may be embodied on a computer usable medium, which include storage devices and signals, in compressed or uncompressed form. Exemplary computer usable storage devices include conventional computer system RAM (random access memory), ROM (read only memory), EPROM (erasable, programmable ROM), EEPROM (electrically erasable, programmable ROM), and magnetic or optical disks or tapes.

Through the foregoing variations, products and methods of dedicated EGR from a cylinder to a first stage turbocharger are provided for enhanced engine performance. The first turbine 42 may also provide a benefit of cooling the dedicated EGR feed gases to the cylinders 50, 52, 54 and 56, and may reduce pressure fluctuations in the exhaust flow leaving the cylinder 50. The description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may involve a product that may include an engine that may have a set of cylinders, one cylinder of which may deliver a first stream of exhaust gases to a first conduit. All cylinders in the set of cylinders other than the one cylinder may comprise a subset of cylinders that may deliver a second stream of exhaust gases to a second conduit. An intake system may supply the set of cylinders with a combustion air. A first turbocharger may have a first turbine driving a first compressor and a second turbocharger may have a second turbine driving a second compressor. The combustion air may be charged in the intake system through the first and second compressors, and the first stream of exhaust gases from the one cylinder may be routed through the first turbine.

Variation 2 may include the product according to variation 1 wherein the first stream of exhaust gases may be recirculated into the intake system which may provide EGR from the one cylinder as a dedicated cylinder for the EGR.

Variation 3 may include the product according to variation 1 wherein the second stream of exhaust gases from the subset of cylinders may be routed through the second turbine.

Variation 4 may include the product according to variation 1 wherein the first turbocharger may provide a first stage boost and the second turbocharger may provide a second stage boost. Intake air may be first channeled through the first turbine and then may be channeled through the second turbine, after which the intake air may be mixed with the first stream of exhaust gases and may then be delivered into the engine through the intake system.

Variation 5 may include the product according to variation 1 and may include a first conduit that may connect the first turbine with the intake system and through which the first stream of exhaust gases may be channeled. A second conduit may channel the second stream of exhaust gases to a discharge. A treatment device may be disposed in the second conduit. A third conduit may connect the first conduit with the second conduit and through which the first stream of exhaust gases may be selectively channeled to the treatment device.

Variation 6 may include the product according to variation 1 wherein none of the second stream of exhaust gases may be recirculated into the intake system.

Variation 7 may include the product according to variation 1 wherein the set of cylinders may each include a first exhaust port and a second exhaust port. Each of the first exhaust ports of the subset of cylinders may deliver a first part of the second stream of exhaust gases to a blowdown manifold. Each of the second exhaust ports of the subset of cylinders may deliver a second part of the second stream of exhaust gases to a scavenge manifold. A first conduit may connect the blowdown manifold with the second turbine so that the first part may be channeled through the second turbine. A second conduit may connect with the scavenge manifold and may bypass the second turbine.

Variation 8 may include the product according to variation 1 wherein the first stream of exhaust gases may be recirculated into the intake system and through the first compressor, which may provide dedicated EGR from the one cylinder.

Variation 9 may include the product according to variation 1 wherein each cylinder in the set of cylinders may each include a first exhaust port and a second exhaust port. The first exhaust port of the one cylinder may deliver a first part of the first stream of exhaust gases to a first passage and the second exhaust port of the one cylinder may deliver a second part of the first stream of exhaust gases to a second passage. The first and second passages may join and then may channel the first stream of exhaust gases in entirety to the first turbine.

Variation 10 may include the product according to variation 1 wherein the set of cylinders may each include a first exhaust port and a second exhaust port. The first exhaust port of the one cylinder may deliver a first part of the first stream of exhaust gases to a first passage. The second exhaust port of the one cylinder may deliver a second part of the first stream of exhaust gases to a second passage. The first passage may be connected with the first turbine and the second passage may bypass the first turbine.

Variation 11 may include the product according to variation 1 wherein each cylinder in the set of cylinders may include a first exhaust port and a second exhaust port. The first exhaust port of the one cylinder may deliver a first part of the first stream of exhaust gases to a first passage and the second exhaust port of the one cylinder may deliver a second part of the first stream of exhaust gases to a second passage. The first passage may be connected with the first turbine and the second passage may bypass the first turbine. A third passage may connect the first turbine with an inlet of the first compressor. The first part may be channeled through the first turbine and then through the first compressor. The second part may be channeled to bypass the first turbine.

Variation 12 may include the product according to variation 1 and may include a third conduit that may connect an outlet of the first turbine with an inlet of the first compressor. The first stream of exhaust gases may be channeled through the first turbine, the third conduit and the first compressor.

Variation 13 may involve a product that may include an engine that may have a first cylinder and a number of additional cylinders. A first turbocharger may include a first turbine and a first compressor. A first stream of exhaust gases from the first cylinder may be channeled through the first turbine. A second turbocharger may include a second turbine and a second compressor. A second stream of exhaust gases from the number of additional cylinders may be channeled through the second turbine. An air inlet may provide a combustion air to the engine that may be channeled first through the first compressor and second through the second compressor and then into the engine.

Variation 14 may include the product according to variation 13 wherein the first stream of exhaust gases may be channeled into the engine with the combustion air, and the first cylinder may provide a dedicated EGR supply to the engine.

Variation 15 may include the product according to variation 13 and may include a conduit that may connect an outlet of the first turbine with an inlet of the first compressor. The first stream of exhaust gases may first be channeled through the first turbine, and may then be channeled through the conduit and may then channeled through the first compressor, and may then channeled through the second compressor.

The above description of select variations within the scope of the invention is merely illustrative in nature and, thus, variations or variants thereof are not to be regarded as a departure from the spirit and scope of the invention.

What is claimed is:

1. A product comprising an engine having a set of cylinders with one cylinder in the set of cylinders delivering a first stream of exhaust gases to a first conduit and all cylinders in the set of cylinders other than the one cylinder comprising a subset of cylinders that deliver a second stream of exhaust gases to a second conduit, an intake system supplying the set of cylinders with a combustion air, wherein the intake system comprises an air inlet, a first turbocharger with a first turbine driving a first compressor and a second turbocharger with a second turbine driving a second compressor, the combustion air charged in the intake system through the first and second compressors, and the first stream of exhaust gases from the one cylinder being routed through the first turbine; and wherein the first turbocharger provides a first stage boost and the second turbocharger provides a second stage boost wherein intake air consisting of air from the air inlet is first channeled through the first compressor and then through the second compressor after which the intake air is mixed with the first stream of exhaust gases and is then delivered into the engine through the intake system.

2. The product according to claim 1 wherein the first stream of exhaust gases is recirculated into the intake system providing EGR from the one cylinder as a dedicated cylinder for the EGR.

3. The product of claim 1 wherein the second stream of exhaust gases from the subset of cylinders is routed through the second turbine.

4. (canceled)

5. The product of claim 1 comprising a first conduit connecting the first turbine with the intake system through which the first stream of exhaust gases is channeled and a second conduit channeling the second stream of exhaust gases to a discharge, with a treatment device disposed in the second conduit, and a third conduit connecting the first conduit with the second conduit through which the first stream of exhaust gases is selectively channeled to the treatment device.

6. The product of claim 1 wherein none of the second stream of exhaust gases is recirculated into the intake system.

7. The product of claim 1 wherein in the set of cylinders each cylinder includes a first exhaust port and a second exhaust port wherein each of the first exhaust ports of the subset of cylinders delivers a first part of the second stream of exhaust gases to a blowdown manifold and each of the second exhaust ports of the subset of cylinders delivers a second part of the second stream of exhaust gases to a scavenge manifold, a first conduit connecting the blowdown manifold with the second turbine so that the first part is channeled through the second turbine and a second conduit connecting with the scavenge manifold and bypassing the second turbine.

8. The product according to claim 1 wherein the first stream of exhaust gases is recirculated into the intake system and through the first compressor, providing dedicated EGR from the one cylinder.

9. The product of claim 1 wherein in the set of cylinders each cylinder includes a first exhaust port and a second exhaust port wherein the first exhaust port of the one cylinder delivers a first part of the first stream of exhaust gases to a first passage and the second exhaust port of the one cylinder delivers a second part of the first stream of exhaust gases to a second passage, wherein the first and second passages join with one another and then channel the first stream of exhaust gases in entirety to the first turbine.

10. The product of claim 1 wherein in the set of cylinders each cylinder includes a first exhaust port and a second exhaust port wherein the first exhaust port of the one cylinder delivers a first part of the first stream of exhaust gases to a first passage and the second exhaust port of the one cylinder delivers a second part of the first stream of exhaust gases to a second passage, wherein the first passage is connected with the first turbine and the second passage bypasses the first turbine.

11. The product of claim 1 wherein in the set of cylinders each cylinder includes a first exhaust port and a second exhaust port wherein the first exhaust port of the one cylinder delivers a first part of the first stream of exhaust gases to a first passage and the second exhaust port of the one cylinder delivers a second part of the first stream of exhaust gases to a second passage, wherein the first passage is connected with the first turbine and the second passage bypasses the first turbine, and a third passage connecting the first turbine with an inlet of the first compressor wherein the first part is channeled through the first turbine and then through the first compressor and the second part is channeled to bypass the first turbine.

12. The product of claim 1 comprising a third conduit connecting an outlet of the first turbine with an inlet of the first compressor wherein the first stream of exhaust gases is channeled through the first turbine, the third conduit and the first compressor.

13. A product comprising an engine that has a first cylinder and a number of additional cylinders, a first turbocharger with a first turbine and a first compressor, with a first stream of exhaust gases from the first cylinder channeled through the first turbine, and a second turbocharger with a second turbine and a second compressor, with a second stream of exhaust gases from the number of additional cylinders channeled through the second turbine, and a combustion air consisting of air from an air inlet to the engine that is constructed and arranged to channel the combustion air first through the first compressor and second through the second compressor and then into the engine and wherein the air inlet is constructed and arranged to channel the first stream of exhaust gases into the engine with the combustion air and the first cylinder provides a dedicated EGR supply to the engine.

14. (canceled)

15. The product of claim 13 comprising a conduit connecting an outlet of the first turbine with an inlet of the first compressor wherein the first stream of exhaust gases is first channeled through the first turbine, and is then channeled through the conduit and is then channeled through the first compressor, and is then channeled through the second compressor.
